(19) United States
(12) Patent Application Publication
(10) Pub. No.: US 2005/0143844 A1
(43) Pub. Date: Jun. 30, 2005

(54) Measuring device with competing process control

(76) Inventors: Andreas Gerster, Eutingen (DE); Stefan Walther, Herrenberg (DE); Martin Hilliges, Gartringen (DE)

Correspondence Address: PERMAN & GREEN, 425 POST ROAD, FAIRFIELD, CT, 06824, US

(21) Appl. No.: 10/504,458

(22) PCT Filed: Jul. 10, 2002
(86) PCT No.: PCT/EP02/07668

(30) Foreign Application Priority Data
May 3, 2002 (EP) 02009907.3

(51) Int. Cl. G05B 11/01

(52) U.S. Cl. 700/26

(57) ABSTRACT

A measuring device (10) comprises at least one measuring unit (35), each for executing at least one measurement function, and an application control unit (40) for controlling and/or administering competing processes caused by plural application interfaces acting and/or cooperating with the measuring device. Each application interface represents an application initiating and/or executing at least one measurement function, or a part thereof, and/or handling a measurement result of at least one measurement function.

### BACKGROUND OF THE INVENTION

Measuring devices generally comprise a measuring unit for executing the measurement and a user interface allowing a user to control the measurement and to read out measurement results. While most measurement devices generally physically incorporate such user interface, it is also known to provide such user interface through a computer system coupled to the measuring device e.g. through a GPIB-bus, or another known bus system.

### SUMMARY OF THE INVENTION

It is an object of the present invention to provide an improved measuring system. The object is solved by the independent claims. Preferred embodiments are shown by the dependent claims.

According to the present invention, a measuring device comprises at least one measuring unit, each being adapted for (preferably physically) executing at least one measurement function. Such measurement function can be, for example, to measure a physical parameter (e.g. power, loss, frequency, etc.) of a device under test (DUT). The measuring device further comprises an application control unit adapted for controlling and/or administering competing processes caused by plural application interfaces acting on and/or cooperating with the measuring device.

The term “application interface” as used herein shall represent any kind of application initiating and/or executing a measurement function, or a part thereof, and/or handling a measurement result of a measurement function. Handling a measurement result might be any kind of visualization (e.g. printing, plotting, displaying, et.), data deposition (e.g. storing), data processing (e.g. pre- or post-processing of measuring results), etc. The application interface might be represented by a user interface, a program (such as a computer program) or algorithm, feedback system, etc. The application interface might be internal or external with respect to the measuring device, and couple with the measuring device through any kind of transmission path (e.g. wired or wireless) again internal or external with respect to the measuring device. A connection unit might be provided at the measuring device allowing coupling one or more external application interfaces to the measuring device.

Competing processes can be caused e.g. by at least one of the following: one measurement function and/or result is accessed by different application interfaces, different but interrelated measurement functions and/or results are accessed by at least one application interface, different application interfaces are differently controlling one measuring unit or plural but interrelated measuring units at the same time or as long as a current measurement function is executed, representing and/or modifying (e.g. same) measuring results by different application interfaces, etc.

While the measuring device might comprise an own local application interface, one or more external application interfaces might be coupled through the connection unit to the measuring device. The application control unit administers the access of all application interfaces (whether external or internal) onto each measuring unit and further controls access of the application interfaces for competing processes, so that e.g. a measurement function and/or result controlled by one application interface (coupled to the measuring device) will not be interfered by another measurement function and/or result controlled by another application interface (also coupled to the measuring device).

In case that e.g. one of the application interfaces modifies measurement results, the application control unit will coordinate such modification with the one or more other application interfaces also accessing those measurement results. Such coordination can be e.g. that any modification executed will be automatically provided to all other application interfaces representing those measurement results.

Each external application interface adapted to be coupled to the measuring device preferably comprises an application connection unit for coupling the external application interface through the transmission path to the connection unit of the measuring device. Further, each external application interface preferably comprises a control unit for controlling measurement function(s) to be executed, and/or for controlling a representation unit for representing information e.g. about the measurement function(s) to be executed, control parameters set by the control unit, and/or measurement results provided from the measuring device. The representation unit might comprise a display, monitor, or the like.

In one embodiment, one or more application interfaces can be applied for controlling the measuring device as well as for only representing information about measurements actually controlled e.g. by a different application interface.

In case that one application interface wants to act on a measurement controlled by a different application interface, the application control unit of the measuring device will examine that request for potential influences on this or other measurement functions and/or results and will preferably either allow, reject or postpone such request, e.g. dependent on information available to the application control unit such as e.g. priorities, overrides, algorithms, rule-sets, etc. The application control unit can thus allow and control coexistence of plural application interfaces without adversely influencing each other or the measurements.

In a preferred embodiment, the transmission path is embodied as a network, which can be provided as wired and/or wireless network. Preferably, a LAN or a WAN is used.

In one embodiment, each application interface further comprises an identification unit allowing unambiguously identifying each application interface. This is in particular useful when plural (e.g. external) application interfaces act on the measuring device. Identification can be realized by (e.g. automatically) adding a unique identifier ID of the requesting application interface to each request. This ID may e.g. be passed to the application interface by the application control unit when the application interface contacts the measuring device the first time.

In a preferred embodiment, the application control unit provides control for competing processes caused by requests from one coupled application interface, e.g. resulting from concurrently initiating or executing competing measurement functions. (by the same or different measuring units). For that purpose the application control unit might execute a consistency check for each request for a measurement function or result.

In operation when only one application interface is coupled to the measuring device, the application control unit will e.g. fully allow the coupled application interface to control each measuring device or restrict access of the application interface e.g. depending to a predefined set of rules.

In operation when plural (internal and/or external) application interfaces are coupled to the measuring device, the application control unit will receive all requests from each application interface (e.g. to control a respective measuring unit or to receive or modify information about measurements including measurement results). The application control unit preferably uses the application interface ID, which preferably is a part of the request, to identify the initiator of the request and to decide whether to allow the execution of the request, to postpone or to reject the request. In addition depending on its configuration, the application control unit may inform other application interfaces about the request. The actual behavior of the application control unit depends on the current access rights of the application interface to the measuring device.

In a preferred embodiment, plural measuring devices are coupled through respective connection units to a network. Each measuring device preferably has a unique address within the network. Each application interface coupled within the network can then individually address each measuring device for providing control or exchanging information as explained above. Thus, each measuring device within the network can be controlled e.g. from remote by a remote (e.g. external) application interface coupled to the network. Accordingly, each application interface can receive information from each measuring device within the network.

In a preferred embodiment, a synchronization is provided in order to reduce or avoid dead lock situations caused e.g. when more than one application interfaces access on more than one measuring units (of one or more measuring devices). Such dead lock situation might arise e.g. when two application interfaces are each holding an exclusive access on a respective one of the measuring units, but both application interfaces are ‘waiting’ to access other one of the measuring units (for example before resuming from the exclusive access). Such synchronization can be accomplished e.g. by establishing a ‘master-slave’ relationship, so that one application control unit is the ‘master’ application control unit and all other ‘slave’ application control units must synchronize requests with this ‘master’ application control unit.

Deadlock situation can be avoided, if every application interface has only exclusive access to one set of measuring units at one time and first has to give back access rights of the complete set once it needs a modified set of measuring units and to acquire exclusive access rights to the modified set from the application control unit within one step. Depending on the current state of the measuring device, the application control unit may give exclusive access or not.

Preferred embodiments of the invention thus allow providing an entirely new architecture for measuring devices by breaking off—without virtually any limitation —the conventionally rigid linkage between measuring unit and application interface. Embodiments of the invention even allow to fully separate (e.g. physically) measuring units from application interfaces, so that no local application interface is required. On the other hand, since plural measuring devices in preferred embodiments are controllable e.g. by one application interface, effective control, e.g. on production floor with several measuring devices can be achieved e.g. even from (physically) remote.

In a preferred embodiment, an external application interface can be embodied as either one of a standard server or desktop computer, a notebook computer, a pen tablet computer, a handheld computer, or pocket computer, as well as a PDA or a mobile phone, or a hardware feedback system, e.g. an automatic positioning system. If the external application interface runs on a computer, it may be either equipped with a graphical user interface or may run as a service without any graphical representation. If the external application interface is equipped with a graphical user interface, it preferably uses a touch-screen for easy pen-based operation. Examples for those touch-screen based computers are the LifeBook B Series notebook PC or the Stylistic 3500, Stylistic LT P-600 or PenCentra 200 pen tablet PC provided from Fujitsu Computers.

The invention can be partly or entirely embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference signs).

FIG. 1 illustrates an example according to the present invention.

### DETAILED DESCRIPTION OF THE INVENTION

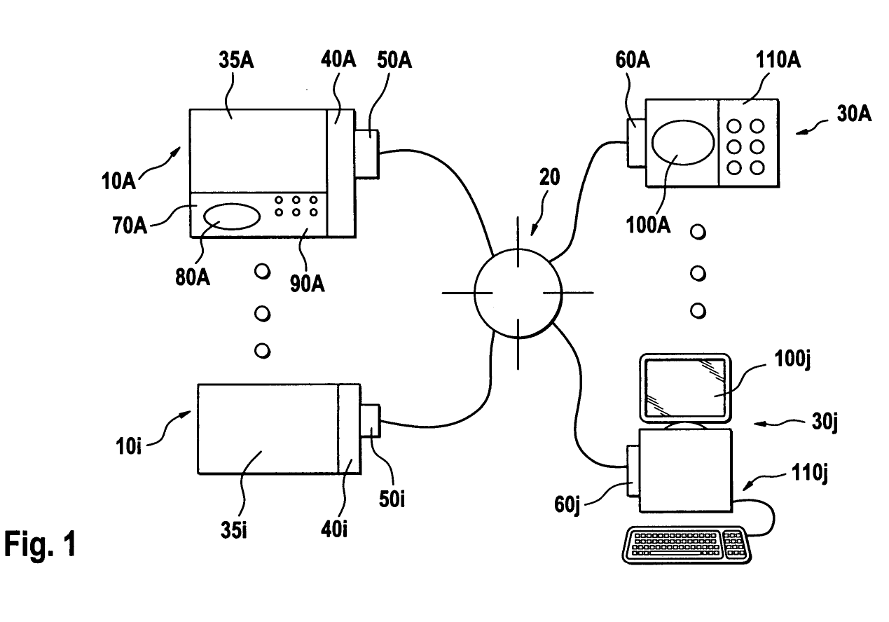

In FIG. 1, a plurality of measuring devices 10A, . . . 10i are coupled to a network 20. A plurality of external (with respect to the measuring devices 10i) application interfaces 30A, . . . , 30j are further coupled to the network 20, which can be any kind of network e.g. using wired and/or wireless transmission.

Each measuring device 10 comprises at least one measuring unit 35 each for executing a respective measurement function, an application control unit 40 for controlling access of one or more application interfaces, and a connection unit 50 for connecting to the network 20. Each external application interface 30 also comprises an application connection unit 60 for connecting to the network 20.

In the example of FIG. 1, the measuring device 10A further comprises a local application interface 70A having a display 80A and control unit 90A. While the control unit 90A allows controlling measurement functions provided by each measuring unit 35A, the display 80A allows displaying measurement information such as measuring results provided by each measuring unit 35A. In contrast to the measuring device 10A, the measuring device 10i does not comprise an own local application interface.

In the example of FIG. 1, the external application interface 30A comprises a display 100A and a control unit 110A just in accordance with the functions of the display 80A and the control unit 90A. The external application interface 30j in the example of FIG. 1 is embodied as a general data processing unit having a monitor 100j and a control unit 110j comprised of a standard processing unit with a terminal.

Each device coupled to the network 20 is provided with a unique address within the network 20.

In the example as shown here, the application interfaces substantially represent user interfaces each allowing a user interaction. However, other type of application interfaces with or without option for user invention can be applied accordingly, or example for periodically and/or automatically executing measuring functions and/or to periodically and/or automatically requesting measuring results (e.g. for graphical representation or storing).

In operation, each measuring unit 35 of each measuring device 10 can be controlled by one or more of the (local or external) application interfaces (70/30). In an example wherein the measuring device 10A is to be controlled by its local application interface 70A as well by the external application interface 30A, the application control unit 40A will control each access of the local application interface 70A as well as of the external application interface 30A onto the measuring unit 35A. In case that the application control unit 40A detects competing processes requested by both application interfaces 70A and 30A, the application control unit 40A will administer such competing processes and provides control to either one of the application interfaces 70A and 30A, dependent on pre-given information such as access priorities etc.

In an example, wherein the local application interface 70A presently controls a measurement executed by the measurement unit 35A, and the external application interface 30A requests the measurement unit 35A to execute a different measurement, the application control unit 40A will—dependent on its setting—either refuse the request from the external application interface 30A, pause the current measurement requested from the local application interface 70A, or wait with an execution of the request from the external application interface 30A until the currently measurement controlled by the local application interface 70A has been terminated.

In an example wherein the measuring unit 35A presently executes a measurement requested and controlled by the external application interface 30A, and the local application interface 70A requests a modification of the current measurement, the application control unit 40A determines the priority of the application interfaces 70A and 30A and will assign control of the measuring unit 35A to either one of the external application interfaces 30A or 70A dependent which one has the higher priority. In case that the external application interface 30A has higher priority, the application control unit 40A might reject the request from the local application interface 70A. In case that the priority of the local application interface 70A is higher than the priority of the external application interface 30A, the application control unit 40A might allow the request to modify the measurement.

In case that plural application interfaces 30 request control over one of the measuring units 35, the corresponding application control unit 40 will handle such request accordingly.

As seen from the example of FIG. 1, the measuring device 10i can also be provided without local application interface and might be controlled by any one or plural of the external application interfaces 30 or even by the local application interface 70A of a different measuring device 10A.

1. A measuring device comprising:
one or more measuring units, each being adapted for executing at least one measurement function, and
an application control unit adapted for controlling and/or administering competing processes caused by plural application interfaces acting and/or cooperating with the measuring device,
wherein each application interface represents an application initiating and/or executing at least one measurement function, or a part thereof, and/or handling a measurement result of at least one measurement function.

2. The measuring device according to claim 1, further comprising a connection unit adapted for coupling one or more external application interfaces, external with respect to the measuring device, through a transmission path to the measuring device.

3. The measuring device according to claim 1, further comprising an own local application interface.

4. The measuring device according to claim 1, wherein the handling of a measurement result comprises at least one of: visualization, data deposition, or data processing.

5. The measuring device according to claim 1, wherein at least one application interface comprises at least one of a user interface, a program or algorithm, or a feedback system.

6. The measuring device of claim 1, wherein competing processes of plural application interfaces are caused by at least one of the following: one measurement function and/or result is accessed by different application interfaces, different but interrelated measurement functions and/or results are accessed by at least one application interface, different application interfaces are differently controlling one measuring unit or plural but interrelated measuring units at the same time or as long as a current measurement function is executed, representing and/or modifying measuring results by different application interfaces.

7. The measuring device according to claim 1, wherein the application control unit is adapted to administer access of all application interfaces onto each measuring unit and/or to control access of the application interfaces for competing processes.

8. The measuring device according to claim 1, wherein the application control unit is adapted to control access of the application interfaces for competing processes so that a measurement function controlled by one application interface, coupled to the measuring device, will not be interfered by another measurement function controlled by another application interface, coupled to the measuring device.

9. The measuring device according to claim 1, wherein the application control unit coordinates a modification of measurement results provided by one of the application interfaces with each other application interfaces accessing those measurement results.

10. A measuring system, comprising:
the measuring device according to claim 1, and
one or more application interfaces adapted to be coupled to the measuring device, each application interface comprising:
an application connection unit for coupling the external application interface through a transmission path to the connection unit of the measuring device, and
a control unit for controlling at least one of: one or more measurement functions to be executed by the measuring device, a representation unit for representing information, control parameters set by the control unit, and measurement results provided from the measuring device.

11. The measuring system of claim 10, wherein at least one external application interface is applied for controlling the measuring device as well as for representing information about measurements controlled by a different application interface.

12. The measuring system of claim 10, wherein in case that one application interface wants to act on a measurement function controlled by a different application interface, the application control unit of the measuring device will examine that request for potential influences on this or other measurement functions and will either allow, reject or postpone such request, dependent on information available to the application control unit.

13. The measuring system of claim 10, wherein each application interface further comprises an identification unit allowing unambiguously identifying each application interface.

14. The measuring system of claim 13, wherein the identification unit is adapted for adding a unique identifier of the requesting application interface to each request.

15. The measuring system of claim 10, further comprising plural measuring devices, each coupled through its connection unit to the network.

16. The measuring system of claim 15, wherein each measuring device has a unique address within the network.

17. The measuring system of claim 15, wherein each application interface can individually address each measuring device for providing control or exchanging information.

18. A method for operating a measuring system of claim 10, the method comprising the steps of:
(a) when only one application interface is coupled to one measuring device: allowing full or limited access for the coupled application interface to control the one measuring device,
(b) when plural application interfaces are coupled to one measuring device: receiving all requests from each application interface to either control the one measuring device or to receive or modify information about measurement functions and/or measurement results, and controlling and administering competing processes caused by the plural application interfaces acting and/or cooperating with the one measuring device.

19. The method of claim 18, further comprising the step of:
providing a synchronization in order to reduce or avoid dead lock situations caused by requests from more than one application interfaces accessing one measuring device.

20. The method of claim 19, further comprising the steps of:
establishing a master-slave relationship, so that one application control unit represents the master application control unit and all other slave application control units must synchronize requests with this ‘master’ application control unit.

21. The method of claim 19, further comprising the steps of:
providing exclusive access for one application interface only to one set of measuring functions during a time interval,
removing the exclusive access when a modified set of measuring functions is requested the one application interface.

22. A software program or product, preferably stored on a data carrier, for executing the method of claim 18 when run on a data processing system such as a computer.
